(19) United States
(12) Patent Application Publication
(10) Pub. No.: US 2026/0080483 A1
(43) Pub. Date: Mar. 19, 2026

(54) IOT ENABLED SYSTEM FOR UNDERWATER NUTRIENTS HARVESTING IN FLOAT FARMING

(71) Applicant: International Business Machines Corporation, Armonk, NY (US)

(72) Inventors: Sarbajit Kumar Rakshit, KOLKATA (IN); Jagabondhu Hazra, BANGALORE (IN); Manikandan Padmanaban, Chennai (IN)

(73) Assignee: International Business Machines Corporation, Armonk, NY (US)

(21) Appl. No.: 18/889,654

(22) Filed: Sep. 19, 2024

(51) Int. Cl. G06Q 50/02; G06Q 10/0631; G06Q 10/0637

(52) U.S. Cl. CPC G06Q 50/02; G06Q 10/06315; G06Q 10/0637

(57) ABSTRACT

An embodiment analyzes, to determine a value of a chemical compound, a first sensor data to determine a density of the chemical compound, where the chemical compound is emitted from a candidate underwater source in a water body where an operation of a floating farm operation is conducted. The embodiment performs a cost-benefit analysis using the value of the chemical compound and a cost of using the chemical compound in the operation of the floating farm. The embodiment causes, in response to the cost-benefit analysis justification for an upwelling movement, the upwelling movement of an upwelling apparatus to a submerged location in the water body. The embodiment causes, in response to the cost-benefit analysis justification for a farm relocation, the farm relocation of the floating farm to a surface location in the water body.

### BACKGROUND

The present invention relates generally to the field of Internet of Things (IoT) enabled software applications and systems for automation. More particularly, the present invention relates to a method, system, and computer program for IoT-enabled system for underwater nutrient harvesting in float farming.

Floating farms are agricultural or aquacultural facilities designed to operate on water bodies. Floating farms combine agriculture and floating technology, and use systems that enable plant or animal farming on floating platforms. These agricultural entities are farming setups located on or near coastal areas, often in the ocean or large lakes, and emphasize the water-based aspect of the farming system, whether for crops, fish, or other aquatic life.

A key aspect of floating farms—also referred to herein as float farming—is the use of hydroponic systems, where plants are grown on a floating platform in nutrient-rich water using no soil or with a minimal soil base. Some floating farms are deployed in oceanic or marine environments where the farming takes place.

For example, some oceanic platforms are used for aquaculture or seaweed cultivation. As another example, float farming practices are also used for the cultivation of crops on floating platforms or structures and are often seen in regions prone to flooding. Some float farming operations use controlled environments where greenhouses are used to grow crops on water. Another variant of float farming, or floating farms, combines aquaculture for raising fish with hydroponics, on floating platforms.

Floating farms are known by a variety of names, such as float farming, offshore farms, aquatic farms, marine farms, waterborne farms, agro-floating systems, floating agriculture, floating greenhouses, aquaponic rafts, floating food production units, and floating hydroponic farms. In this disclosure, such terms are their respective implementation variants are contemplated within the scope of the illustrative embodiments, and the embodiments described herein can be adapted to such variants without departing the scope of this disclosure.

### SUMMARY

The illustrative embodiments provide for IoT-enabled system for underwater nutrient harvesting in float farming. An embodiment includes analyzing, to determine a value of a chemical compound, a first sensor data to determine a density of the chemical compound, wherein the chemical compound is emitted from a candidate underwater source in a water body where an operation of a floating farm operation is conducted. The embodiment includes performing a cost-benefit analysis using the value of the chemical compound and a cost of using the chemical compound in the operation of the floating farm. The embodiment includes causing, responsive to the cost-benefit analysis justification for an upwelling movement, the upwelling movement of an upwelling apparatus to a submerged location in the water body. The embodiment includes causing, responsive to the cost-benefit analysis justification for a farm relocation, the farm relocation of the floating farm to a surface location in the water body.

Other embodiments of this aspect include corresponding computer systems, apparatus, and computer programs recorded on one or more computer storage devices, each configured to perform the actions of the embodiment.

An embodiment includes a computer-usable program product. The computer-usable program product includes a computer-readable storage medium and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration for IoT-enabled system for underwater nutrients harvesting in float farming in accordance with an illustrative embodiment;

FIG. 3 depicts a block diagram of an example application for analysis and actuation in accordance with an illustrative embodiment;

FIG. 4 depicts a flowchart of an example process for IoT-enabled system for underwater nutrients harvesting in float farming in accordance with an illustrative embodiment; and

FIG. 5 depicts an example operation for IoT-enabled system for underwater nutrients harvesting in float farming in accordance with an illustrative embodiment.

### DETAILED DESCRIPTION

The illustrative embodiments recognize that a significant bottleneck of float farming is the excessive cost of fertilizers and fertilizer delivery to floating farm structures. On average, fertilization costs make up roughly 36 percent of the total cost of float farming costs.

The illustrative embodiments further recognize that in a typical float farming operation, roughly 16-38 percent of the nutrients applied via fertilizers drain down to the water bodies on which the farm structures float. This nutrient seepage leads to pollution of the water bodies and causes issues like eutrophication, harmful algal blooms, and oxygen depletion, which negatively impact aquatic ecosystems.

The illustrative embodiments recognize that an opportunity exists in float farming to reduce fertilization-related expenses while simultaneously improving the environmental impact of float farming. The illustrative embodiments recognize that water bodies upon which floating farms are deployed often themselves have sources of nutrients present within them. The nutrient sources inherently present within the water bodies often provide nutrients, such as nitrogen compounds, that are beneficial to the agro-products being farmed on the floating farms. The illustrative embodiments recognize that an opportunity exists to harvest the nutrients from the inherent nutrient sources within the water bodies and reduce fertilization-related expenses while simultaneously improving the environmental impact of float farming.

The illustrative embodiments address the deficiencies and/or opportunities described herein and provide a process (as well as a system, method, and computer program product embodied in a machine-readable medium) for IoT-enabled system for underwater nutrients harvesting in float farming. An embodiment can be used in conjunction with or as a substitute for an existing method for floating farm management. The illustrative embodiments utilize techniques described herein for the IoT-enabled system for underwater nutrients harvesting in float farming using one or more IoT devices.

An IoT device (Internet of Things device) is a physical object, component, appliance, or system, which connects to a data network—such as the internet—and collect, send, or receive data via the connection. These devices are equipped with sensors, software, and other technologies that enable them to interact with their environment, other devices, and users. IoT devices, when associated with other objects or systems for performing specific operations, enable such other objects or systems to become connected to/assimilated in/enabled in a network of smart devices that can automate tasks, provide insights, and improve efficiency.

Within the scope of the illustrative embodiment, the contemplated IoT devices are capable of connecting to a data network, often through Wi-Fi, Bluetooth, cellular networks, or other communication protocols. These IoT devices are configurable to include one or more sensors that collect data from an environment and measure a wide range of variables, such as temperature, humidity, motion, light, pressure, and more. Some IoT devices contemplated herein are enabled to detect the presence of certain chemical compounds, for example, compounds of Nitrogen in water. Some contemplated IoT devices can interact with users or other data processing systems through various interfaces, such as application programming interfaces (APIs), mobile apps, voice or textual commands, or web dashboards.

The contemplated IoT devices can also communicate with other IoT devices to create more complex systems. IoT devices often have some level of processing capability, allowing them to analyze the data they collect before sending it to other devices, cloud services, or applications for further processing. IoT devices are used to automate tasks or control other devices. For example, an IoT device within the contemplations of the illustrative embodiments is envisioned to communicate with a data processing system, receive instructions from said system to change an orientation of an associated device, propel the associated device or cause the associated device to be propelled to a different physical location, change a configuration of the associated device, cause an operation to occur at the associated device as a part of automation of a process involving the associated device.

An IoT device, when configured to operate in conjunction with an embodiment in a manner described herein, provides an improved manner of automated operation of a floating farm for the benefits and advantages, as described herein. An improved float farming setup according to the illustrative embodiments comprises an apparatus for sensing a chemical compound of interest for the purposes of use as a fertilizer in the floating farm. As an example, the sensing apparatus may use spectroscopy or hyperspectroscopy to detect certain chemicals. For example, a submerged sensing apparatus may shine a beam of light on a target at or near a source of a chemical, analyze the spectral properties of the reflected light from the target, and determine from the spectral analysis which compounds, chemicals, or minerals are present at the target. As another example, a sensing apparatus in orbit in space may capture reflected natural light from a target at or near a water surface over a source of a chemical, analyze the spectral properties of the reflected light from the target, and determine from the spectral analysis which compounds, chemicals, or minerals are present at the target.

A sensing apparatus according to the illustrative embodiments is further configured with an IoT device to facilitate an operation described herein. For example, the IoT device may transmit the spectral data to an embodiment on a surface data processing system, where a spectral map of the nutrient density may be created and used in a decision-making process described herein. In another embodiment, the spectral map may be constructed onboard the sensing apparatus and the IoT device may transmit the spectral map to the surface-based embodiment to compute the cost-benefit analysis of the various nutrient locations and densities.

In one embodiment, multiple apparatuses of similar nature and configuration are deployed in different locations relative to a given floating farm. For example, one embodiment comprises one marine-floating and/or submarine-robotic apparatus equipped with a suitable chemical sensor, a propulsion mechanism, and said IoT device. Another embodiment comprises several similarly purposed marine robotic apparatuses, each equipped with a suitable chemical sensor, a propulsion mechanism, and said IoT device. Another embodiment comprises a similarly purposed aerial or airborne apparatus equipped with a suitable chemical sensor, a propulsion mechanism, and said IoT device. Another embodiment comprises a similarly purposed satellite or space-based apparatus equipped with a suitable chemical sensor, a propulsion mechanism, and said IoT device. Another embodiment comprises a combination of marine, aerial, and spatial apparatuses of these types.

An improved float farming setup according to the illustrative embodiments comprises an apparatus for upwelling nutrient-rich water from a submerged nutrient source up to a floating farm. The upwelling apparatus is configured with an IoT device to facilitate an operation described herein.

The term “upwelling” as used herein is a process of artificially raising nutrient-rich water from a submerged source up to the surface where a floating farm is situated. This process is driven by a pumping component of the upwelling apparatus, which is configured with an IoT device to facilitate an operation described herein. A wave pump is one example of the pumping component. The IoT device enables the upwelling apparatus to trigger the pumping On or Off, change a pump speed or delivery volume, cause a propulsion mechanism of the upwelling system to relocate the upwelling apparatus, or a combination thereof, depending on the needs of the floating farm, or another determination made by an embodiment.

For example, once a sensing apparatus according to an embodiment has detected a source of nutrients submerged in the water, and an embodiment has evaluated the cost-benefit analysis to be supportive of using that submerged source, an embodiment causes an upwelling apparatus to reposition relative to the source such that the nutrient-rich water from the source can be upwelled to the floating farm. One embodiment also causes an IoT device associated with a propulsion component of the floating farm to trigger a movement of the floating farm in a position to receive the upwelled nutrient-rich water.

One embodiment executes on a surface-based data processing system. This embodiment receives one or more parameters and/or measurements from a floating farm, a sensing apparatus, an upwelling apparatus, or a combination thereof. Using the measurements, the embodiment performs a cost-benefit analysis as part of a decision-making process.

For example, even if a sensing device detects a nutrient-rich source, the nutrient value may be below a threshold necessary to adequately fertilize the farm, and incurring the cost to relocate the farm over the source and to relocate the upwelling apparatus to upwell from the source may not be justified in the value of the benefits derivable from the source. Conversely, when a sensing device detects a nutrient-rich source, and the nutrient value is at least equal to a threshold necessary to adequately fertilize the farm, incurring the cost to relocate the farm over the source and to relocate the upwelling apparatus to upwell from the source may be justified in the value of the benefits derivable from the source.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting on the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

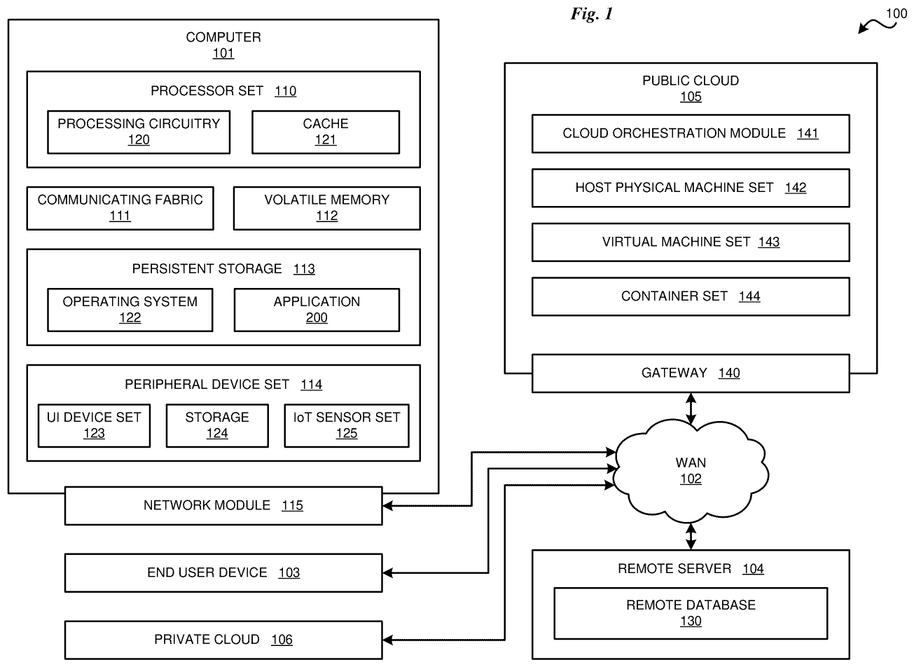

With reference to FIG. 1, this figure depicts a block diagram of a computing environment 100. Computing environment 100 contains an example of an environment for the execution of at least some of the computer code involved in performing the inventive methods, such as application 200 that implements one or more embodiments for IoT-enabled system for underwater nutrients harvesting in float farming as described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip. ” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

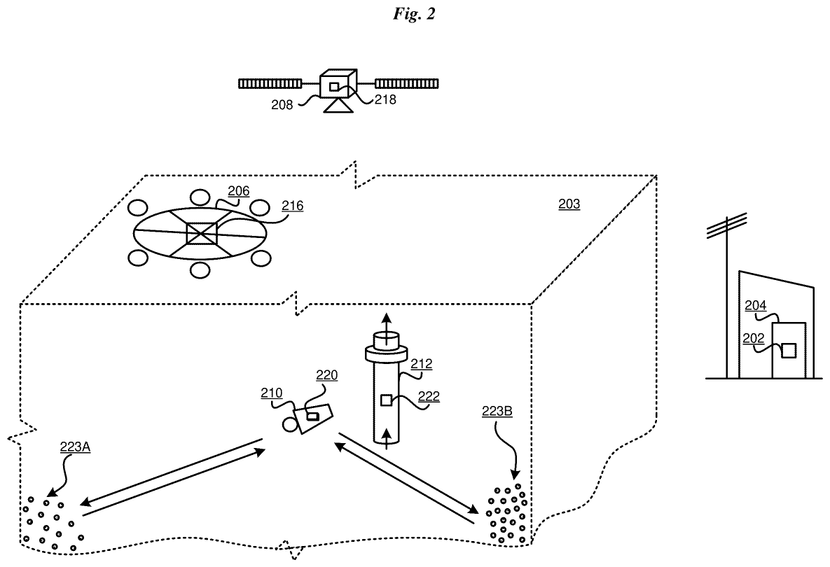

With reference to FIG. 2, this figure depicts a block diagram of an example configuration for IoT-enabled system for underwater nutrients harvesting in float farming in accordance with an illustrative embodiment. Application 202 is an example of application 200 in FIG. 1. Application 202 may execute in a surface-based data processing system 204, as shown. Data processing system 204 may also be located on floating farm 206 or elsewhere. Farm 206 floats in water body 203.

Apparatus 208 is an example space-based sensing apparatus configured in the manner of an embodiment described herein. Apparatus 210 is an example marine-based sensing apparatus configured in the manner of an embodiment described herein. Apparatus 212 is an example upwelling apparatus configured in the manner of an embodiment described herein.

In accordance with one embodiment, floating farm 206 is configured with IoT device 216; sensing apparatus 208 is configured with IoT device 218; sensing apparatus 210 is configured with IoT device 220; and upwelling apparatus 212 is configured with IoT device 222. Assume that in one example operation, sensing apparatus 210 senses nutrients at one or more source regions, e.g., source regions 223A and 223B. IoT device 220 transmits the sensed data to application 202.

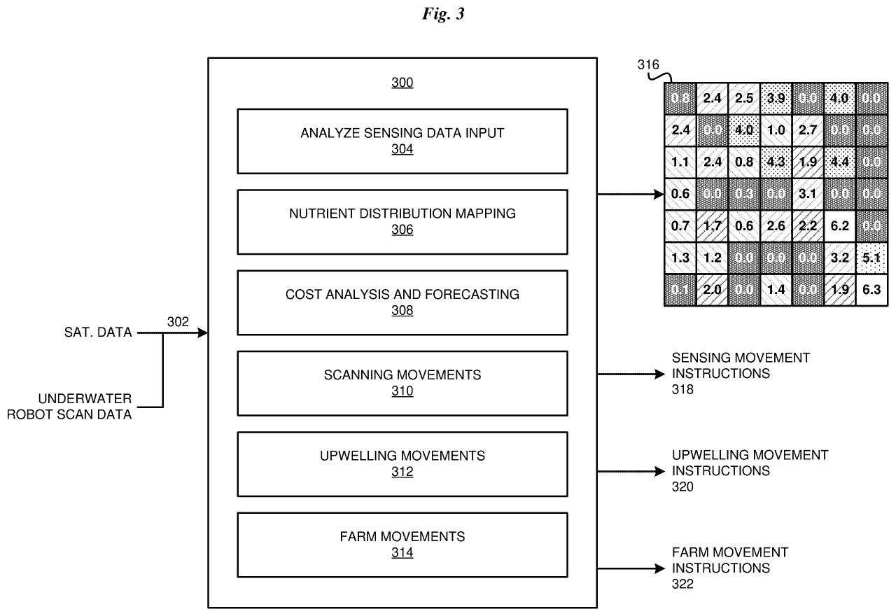

With reference to FIG. 3, this figure depicts a block diagram of an example application for analysis and actuation in accordance with an illustrative embodiment. Application 300 is an example of application 202 in FIG. 2.

Application 300 received sensing data input 302. Input 302 may comprise sensing data received from satellite sensing apparatus, underwater robotic sensing apparatus, or some combination of these and other similarly purposed sensing apparatuses. Component 304 analyzes sensing data input 302 to enable the construction of nutrient densities and distribution mapping. For example, component 304 may be configured to perform spectral (or hyperspectral) analysis of input data 302.

Component 306 constructs a densities and distribution map as described herein. For example, component 306 may construct a map of the densities and distributions of a specific nutrient in regions 223A and 223B of FIG. 2 by using the spectral (or hyperspectral) analysis produced by component 304. Map 316 is an example of such a mapping, and may be optionally output form application 304 for other uses. Map 316 includes a representation (not shown) of regions 223A and 223B of FIG. 2.

Component 308 performs a cost-benefit analysis computation and forecasting. The cost-benefit analysis uses map 316 to determine whether given region 223B would be sufficiently beneficial by computing a value of the nutrient value derivable from regions 223B over a period T by computing a replacement value of an equivalent amount of chemical fertilizer if it were to be procured and delivered to farm 206. Component 308 computes a cost of relocating farm 206 in a location where nutrients are receivable from region 223B. Optionally, the cost of relocation may also include a cost of relocating sensing apparatus 210 and upwelling apparatus 212 proximate to region 223B. In one example cost-benefit analysis computation, if a ratio of the value of nutrients to the total relocation cost and is at least equal to a threshold, component 308 decides that the cost-benefit analysis justifies the relocation. If the ratio is below the threshold, component 308 decides that the relocation is not justified and farm 206 should be supplied with chemical fertilizers procured and delivered to the farm by other means.

Component 308 forecasts a current and future crop growth stage's nutrient requirements. Component 308 forecasts a set of regions, e.g., region 223B and other regions, which could potentially supply all or part of the nutrients needs for a given crop growth stage at a given time. Component 308 also optionally forecasts the period T of viability of regions 223B for supplying the nutrients. For example, given the history of neighboring regions of region 223B, component 308 may be able to forecast a period T after which the nutrients from region 223B will have depleted to a density that would no longer justify keeping upwelling apparatus 212 in a location for upwelling from region 223B.

Component 310 computes and prepares instructions for moving or relocating sensing apparatus 210. Instructions 318 are an example of such instructions and are output from application 300. For example, application 300 sends instructions 318 to IoT device 220 in sensing apparatus 210 of FIG. 2 to cause a propulsion component of sensing apparatus 210 to move sensing apparatus 210 from a present location to a location proximate to region 223B.

Component 312 computes and prepares instructions for moving or relocating upwelling apparatus 212. Instructions 320 are an example of such instructions and are output from application 300. For example, application 300 sends instructions 320 to IoT device 222 in upwelling apparatus 212 of FIG. 2 to cause a propulsion component of upwelling apparatus 212 to move upwelling apparatus 212 from a present location to a location proximate to region 223B.

Similarly, component 314 computes and prepares instructions for moving or relocating farm 206. Instructions 322 are an example of such instructions and are output from application 300. For example, application 300 sends instructions 322 to IoT device 216 in farm 206 of FIG. 2 to cause a propulsion component of farm 206 to move farm 206 from a present location to a location proximate to region 223B.

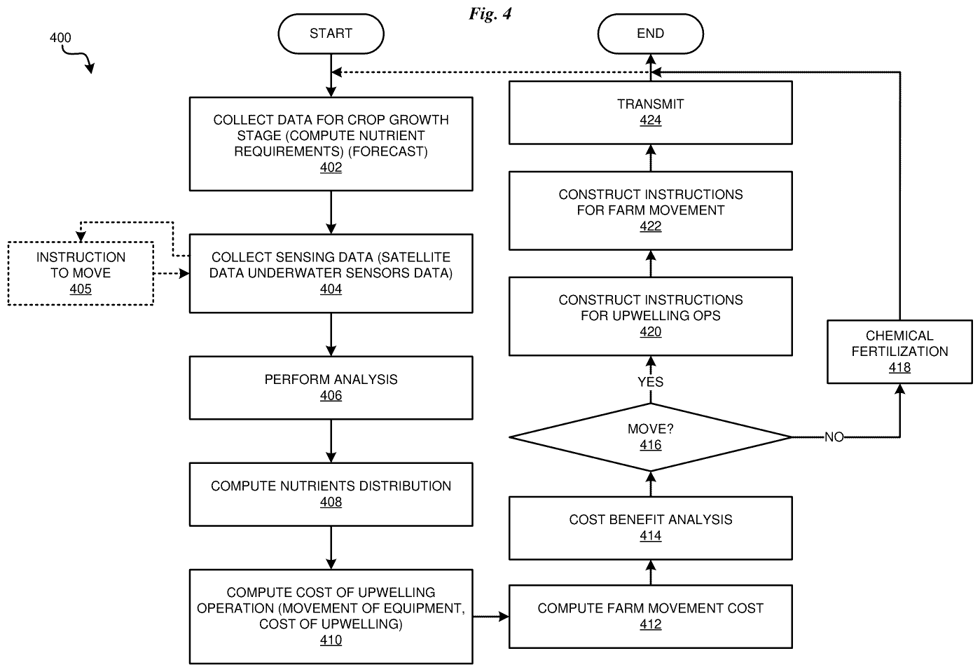

With reference to FIG. 4, this figure depicts a flowchart of an example process for IoT-enabled system for underwater nutrients harvesting in float farming in accordance with an illustrative embodiment. Process 400 can be implemented in application 300 in FIG. 3.

Process 400 collects data for crop growth stage to compute and forecast nutrient needs (block 402). The process collects sensing data from one or more sensing apparatuses (block 404). Optionally and on an as-needed basis, process 400 may produce one or more types of movement instructions to relocate apparatuses and farm platforms as described herein (block 405).

The process performs sensing data analysis (block 406) and computes nutrient densities and distribution, such as by preparing map 316 of FIG. 3 (block 408). The process uses the computations and mapping to determine a cost of upwelling from a candidate nutrient supply region (block 410). The process computes the cost of moving the farm to a receiving position from the candidate regions (block 412). The process performs a cost-benefit analysis as described herein (block 414).

The process determines whether a move to upwell nutrients from the candidate region is justified by the cost-benefit analysis (block 416). If the cost-benefit analysis does not justify the move (“No” path of block 416), the process causes or indicates chemical fertilizer application instead (block 418). Process 400 ends thereafter or optionally returns to block 402 for continuous analysis.

If the cost-benefit analysis justifies the move (“Yes” path of block 416), the process constructs one or more sets of instructions for the relocation of corresponding one or more apparatuses as described herein (block 420). The process constructs a set of instructions to relocate the floating farm platform as well (block 422). The process transmits the instructions to the corresponding IoT devices (block 424) to cause the respective movements. Process 400 ends thereafter or optionally returns to block 402 for continuous analysis.

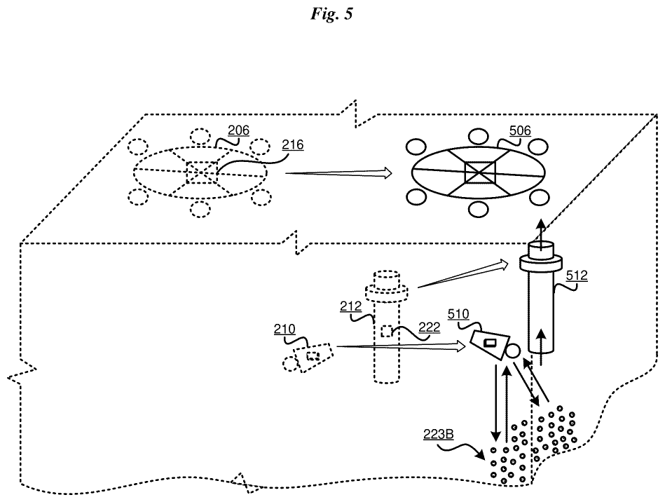

With reference to FIG. 5, this figure depicts an example operation for IoT-enabled system for underwater nutrients harvesting in float farming in accordance with an illustrative embodiment. The setup depicted in FIG. 5 is a progression from the setup depicted in FIG. 2, resulting from the operation of process 400 of FIG. 4.

Assuming that a cost-benefit analysis of candidate region 223B justifies the movements, an embodiment causes farm platform 206 to move to a new location 506 proximate to region 223B. By similar reasoning, the embodiment causes sensing apparatus 210 to relocate to location 510, and upwelling apparatus 212 to location 512 such that nutrient output from candidate region 223B can be (optionally) continuously monitored and upwelled.

The following definitions and abbreviations are to be used for the interpretation of the claims and the specification. As used herein, the terms “comprises,” “comprising,” “includes,” “including,” “has,” “having,” “contains,” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration. ” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
analyzing, to determine a value of a chemical compound, a first sensor data to determine a density of the chemical compound, wherein the chemical compound is emitted from a candidate underwater source in a water body where an operation of a floating farm operation is conducted;
performing a cost-benefit analysis using the value of the chemical compound and a cost of using the chemical compound in the operation of the floating farm;
causing, responsive to the cost-benefit analysis approving an upwelling movement, the upwelling movement of an upwelling apparatus to a submerged location in the water body; and
causing, responsive to the cost-benefit analysis justification for a farm relocation, the farm relocation of the floating farm to a surface location in the water body.

2. The computer-implemented method of claim 1, further comprising:
constructing a set of instructions to cause the upwelling movement; and
transmitting the set of instructions to an Internet of Things (IoT) device associated with the upwelling apparatus, wherein the IoT device uses the set of instructions to cause an activation of a propulsion component of the upwelling apparatus, the propulsion component causing the upwelling movement.

3. The computer-implemented method of claim 1, further comprising:
constructing a set of instructions to cause the farm relocation; and
transmitting the set of instructions to an Internet of Things (IoT) device associated with the floating farm, wherein the IoT device uses the set of instructions to cause an activation of a propulsion component of the floating farm, the propulsion component causing the farm relocation.

4. The computer-implemented method of claim 1, further comprising:
mapping, to produce a map as a part of analyzing, a set of candidate underwater locations, the candidate underwater source being a member of the set of candidate underwater locations, wherein each member of the set of candidate underwater locations has a corresponding density of the chemical compound being emitted, the map depicting densities and distribution of the chemical compound over an underwater area.

5. The computer-implemented method of claim 1, further comprising:
forecasting a duration of viability corresponding to the candidate underwater source;
and using, in the cost-benefit analysis, the duration.

6. The computer-implemented method of claim 1, further comprising:
receiving the first sensor data from a submersible robotic sensing apparatus, wherein the submersible robotic sensing apparatus is monitoring light reflecting from an emission of the candidate underwater source.

7. The computer-implemented method of claim 1, further comprising:
receiving the first sensor data from a space-based satellite sensing apparatus, wherein the satellite sensing apparatus is monitoring light reflecting from a surface of the water body, an emission of the candidate underwater source reaching said surface.

8. The computer-implemented method of claim 1, further comprising:
forecasting a future crop growth stage in the operation of the floating farm, wherein the chemical compound is a nutrient for the future crop growth stage.

9. The computer-implemented method of claim 1, wherein the cost of using the chemical compound in the floating farm operation comprises:
a cost of relocating the floating farm to the surface location on the water body from where the chemical compound can be upwelled from the candidate underwater source, and
a cost of relocating the upwelling apparatus to the submerged location in the water body from where the chemical compound can be upwelled from the candidate underwater source.

10. The computer-implemented method of claim 1, wherein the cost of using the chemical compound is
a cost of using the chemical compound in a future crop growth stage in the operation of the floating farm.

11. The computer-implemented method of claim 1, wherein the cost of using the chemical compound is
a cost of using the chemical compound in a current crop growth stage in the operation of the floating farm.

12. The computer-implemented method of claim 1, further comprising:
computing, as a part of performing the cost-benefit analysis, a ratio of the value of the chemical compound over a period and the cost of using the chemical compound in the operation of the floating farm for the period; and
determining that the ratio is at least equal to a threshold ratio.

13. The computer-implemented method of claim 1, further comprising:
causing, responsive to the cost-benefit analysis justification for a sensing relocation, the sensing relocation of a sensing apparatus to a location proximate to the candidate underwater source.

14. A computer program product comprising:
One or more computer readable storage media; and
program instructions stored on the one or more storage media and configured to perform operations comprising:
analyzing, to determine a value of a chemical compound, a first sensor data to determine a density of the chemical compound, wherein the chemical compound is emitted from a candidate underwater source in a water body where an operation of a floating farm operation is conducted;
performing a cost-benefit analysis using the value of the chemical compound and a cost of using the chemical compound in the operation of the floating farm;
causing, responsive to the cost-benefit analysis approving an upwelling movement, the upwelling movement of an upwelling apparatus to a submerged location in the water body; and
causing, responsive to the cost-benefit analysis justification for a farm relocation, the farm relocation of the floating farm to a surface location in the water body.

15. The computer program product of claim 14, further comprising:
constructing a set of instructions to cause the upwelling movement; and
transmitting the set of instructions to an Internet of Things (IoT) device associated with the upwelling apparatus, wherein the IoT device uses the set of instructions to cause an activation of a propulsion component of the upwelling apparatus, the propulsion component causing the upwelling movement.

16. The computer program product of claim 14, further comprising:
constructing a set of instructions to cause the farm relocation; and
transmitting the set of instructions to an Internet of Things (IoT) device associated with the floating farm, wherein the IoT device uses the set of instructions to cause an activation of a propulsion component of the floating farm, the propulsion component causing the farm relocation.

17. The computer program product of claim 14, further comprising:
mapping, to produce a map as a part of analyzing, a set of candidate underwater locations, the candidate underwater source being a member of the set of candidate underwater locations, wherein each member of the set of candidate underwater locations has a corresponding density of the chemical compound being emitted, the map depicting densities and distribution of the chemical compound over an underwater area.

18. The computer program product of claim 14, wherein the stored program instructions are stored in a computer readable storage device in a data processing system, and wherein the stored program instructions are transferred over a network from a remote data processing system.

19. The computer program product of claim 14, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

20. A computer system comprising a processor and one or more computer readable storage media, and program instructions collectively stored on the one or more computer readable storage media, the program instructions executable by the processor to cause the processor to perform operations comprising:
analyzing, to determine a value of a chemical compound, a first sensor data to determine a density of the chemical compound, wherein the chemical compound is emitted from a candidate underwater source in a water body where an operation of a floating farm operation is conducted;
performing a cost-benefit analysis using the value of the chemical compound and a cost of using the chemical compound in the operation of the floating farm;
causing, responsive to the cost-benefit analysis approving an upwelling movement, the upwelling movement of an upwelling apparatus to a submerged location in the water body; and
causing, responsive to the cost-benefit analysis justification for a farm relocation, the farm relocation of the floating farm to a surface location in the water body.
